(19) United States
(12) Patent Application Publication
(10) Pub. No.: US 2013/0228475 A1
(43) Pub. Date: Sep. 5, 2013

(54) CO-FACIAL ANALYTICAL TEST STRIP WITH STACKED UNIDIRECTIONAL CONTACT PADS AND INERT CARRIER SUBSTRATE

(71) Applicants: Steven John Setford, Inverness (GB); Scott John Sloss, Inverness (GB); Lawrence Julian Ritchie, Inverness (GB)

(72) Inventors: Steven John Setford, Inverness (GB); Scott John Sloss, Inverness (GB); Lawrence Julian Ritchie, Inverness (GB)

(73) Assignee: Cilag GMBH International

(21) Appl. No.: 13/585,330

(22) Filed: Aug. 14, 2012

Related U.S. Application Data
(63) Continuation-in-part of application No. 13/410,609, filed on Mar. 2, 2012.

(51) Int. Cl. G01N 27/327; G01N 27/26

(52) U.S. Cl. 205/782; 204/400; 204/403.02; 205/792

(57) ABSTRACT

An analytical test strip with inert carrier substrate for use with a test meter includes an analytical test strip module and an electrochemically and electrically inert carrier substrate. The analytical test strip module has a first electrode portion, a second electrode portion in an opposing relationship to the first electrode portion, and first and second electrical contact pads configured in a stacked unidirectional configuration. The electrochemically and electrically inert carrier substrate has an upper surface and an outer edge. Moreover, the analytical test strip module is attached to the upper surface of the electrochemically and electrically inert carrier substrate such that the first and second electrical contact pads extend beyond the outer edge of the electrochemically and electrically inert carrier substrate and such that the electrochemically and electrically inert carrier substrate extends beyond the analytical test strip module.

### CROSS-REFERENCE

This application is a continuation-in-part application of U.S. patent application Ser. No. 13/410,609, filed Mar. 2, 2012, which is incorporated herein by reference in its entirety and to which application we claim priority under 35 USC §120.

### BACKGROUND OF THE INVENTION

1. Field of the Invention

The present invention relates, in general, to medical devices and, in particular, to test meters and related methods.

2. Description of Related Art

The determination (e.g., detection and/or concentration measurement) of an analyte in a fluid sample is of particular interest in the medical field. For example, it can be desirable to determine glucose, ketone bodies, cholesterol, lipoproteins, triglycerides, acetaminophen and/or HbA1c concentrations in a sample of a bodily fluid such as urine, blood, plasma or interstitial fluid. Such determinations can be achieved using a hand-held test meter in combination with analytical test strips (e.g., electrochemical-based analytical test strips).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified exploded perspective view of an analytical test strip according to an embodiment of the present invention;

FIG. 2 is a simplified perspective view of the analytical test strip of FIG. 1;

FIG. 3 is a simplified perspective view of a distal portion of the analytical test strip of FIG. 1 in contact with test meter electrical connector pins;

FIG. 4 is a simplified side view of the distal portion of FIG. 3;

FIG. 5 is a top view of a patterned spacer layer of the analytical test strip of FIG. 1;

FIG. 6 is a top view of a third electrically conductive layer of the analytical test strip of FIG. 1;

FIG. 7 is a simplified top view of the analytical test strip of claim 1 with an integrated carrier sheet;

FIG. 8 is a simplified distal end view of the analytical test strip and integrated carrier sheet of FIG. 7

FIG. 9 is a simplified cross-sectional view of the analytical test strip and integrated carrier sheet of FIG. 7;

FIG. 10 is a flow diagram depicting stages in a method for determining an analyte in a bodily fluid sample according to an embodiment of the present invention;

FIG. 11 is a simplified exploded perspective view of an analytical test strip with inert carrier substrate according to an embodiment of the present invention;

FIG. 12 is a simplified perspective view of the analytical test strip with inert carrier substrate of FIG. 11;

FIG. 13 is a simplified view of the distal portion of the analytical test strip with inert carrier substrate of FIG. 11 inserted into a test meter and in contact with electrical connector pins of the test meter;

FIG. 14 is a simplified top view of the distal portion of the analytical test strip with inert carrier substrate inserted into a test meter as also depicted in FIG. 13;

FIG. 15 is a simplified top view of another inert carrier substrate as can be employed in embodiments of the present invention;

FIG. 16 is a simplified top view of yet another inert carrier substrate as can be employed in embodiments of the present invention; and

FIG. 17 is a flow diagram depicting stages in another method for determining an analyte in a bodily fluid sample according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, analytical test strips for use with a test meter (such as a hand-held test meter) according to embodiments of the present invention include a first insulating layer with a first insulating layer upper surface and a first electrically conductive layer disposed on the first insulating layer upper surface. The first electrically conductive layer includes a first electrode portion (such as a working electrode portion) and an electrical contact pad in electrical communication with the first electrode portion. The analytical test strips also include a patterned spacer layer disposed above the first electrically conductive layer. The patterned spacer layer includes (i) a distal portion defining a bodily fluid sample-receiving chamber therein that overlies the first electrode portion and (ii) an insulating proximal portion with an upper surface having a second electrically conductive layer disposed thereon. The second electrically conductive layer includes an interlayer contact portion and an electrical contact pad in electrical communication with the interlayer contact portion.

The analytical test strips further include a second insulating layer that is disposed above the patterned spacer layer and has a second insulating layer lower surface with a third electrically conductive layer disposed thereon. The third electrically conductive layer includes a second electrode portion (such as, for example, a reference/counter electrode) and a proximal portion that overlies the interlayer contact portion.

In addition, the second electrode portion of the analytical test strips is disposed overlying and exposed to the sample-receiving chamber in an opposing (i.e., co-facial) relationship to the first electrode portion. Moreover, the proximal portion is operatively juxtaposed with the interlayer contact portion such that there is an electrical connection between the second electrode portion of the third electrically conductive layer and the electrical contact pad of the patterned spacer layer during use of the analytical test strip.

The electrical contact pad of the first electrically conductive layer and the electrical contact pad of the second electrically conductive layer are referred to as stacked unidirectional contact pads. They are “stacked” since the electrical contact pad of the second electrically conductive layer is elevated with respect to the electrical contact pad of the first electrically conductive layer. They are “unidirectional” since both are on upper surfaces and can, therefore, be accessed and contacted from the same direction.

Analytical test strips according to the present invention are beneficial in that, for example, their configuration and, in particular, the stacked unidirectional nature of the contact pads, is amenable to high-volume, high-yield mass production without dedicated and complex tight-alignment die cutting steps to expose the contact pads.

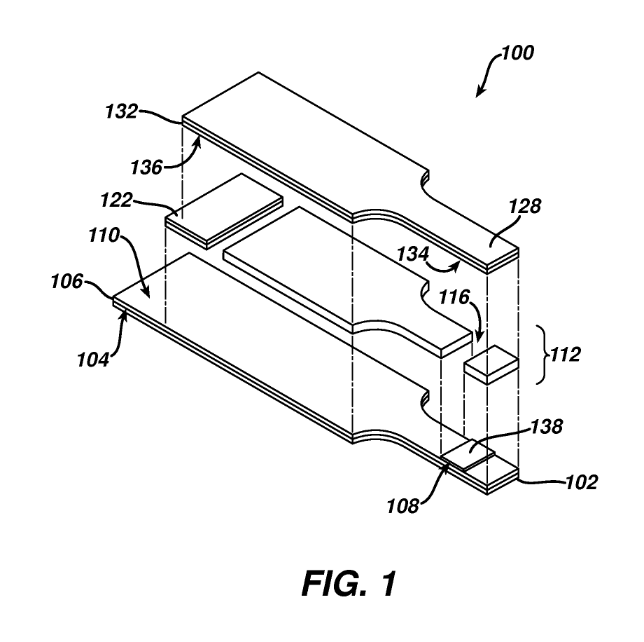

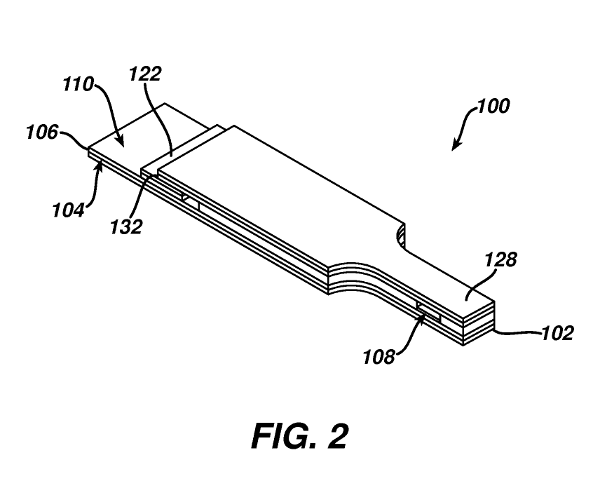

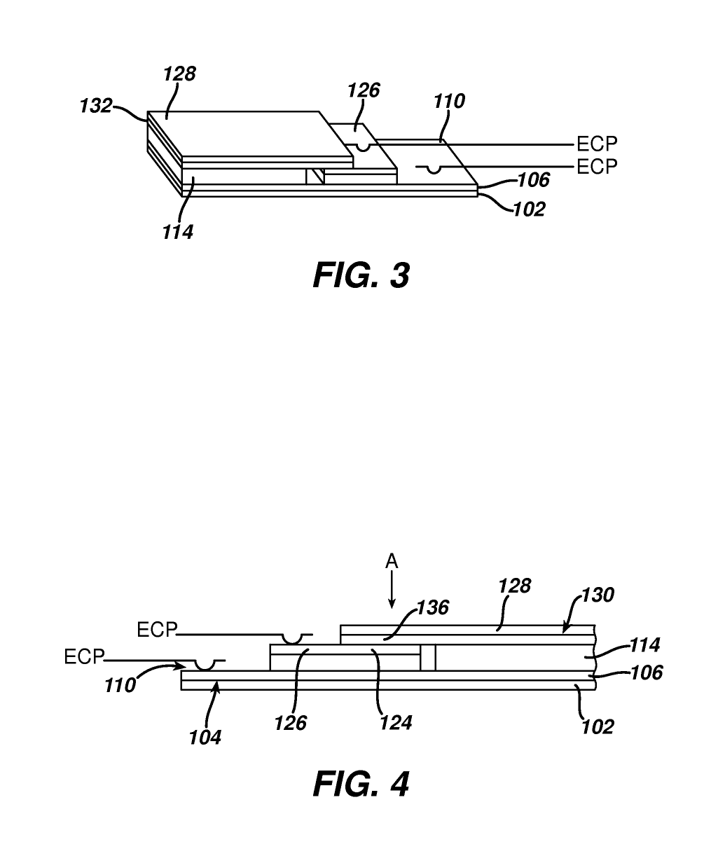

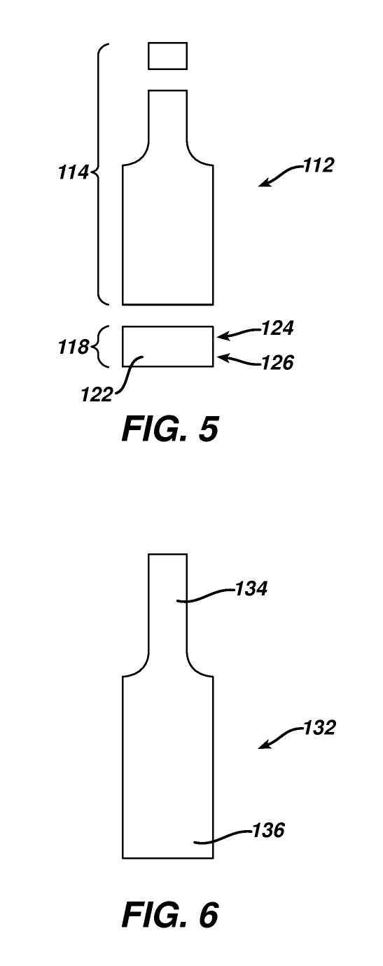

FIG. 1 is a simplified exploded perspective view of an analytical test strip 100 according to an embodiment of the present invention. FIG. 2 is a simplified perspective view of the electrochemical-based analytical test strip of FIG. 1. FIG. 3 is a simplified perspective view of a portion of the electrochemical-based analytical test strip of FIG. 1 in contact with test meter electrical connector pins (ECP). FIG. 4 is a simplified side view of the portion of FIG. 3. FIG. 5 is a top view of a patterned spacer layer of the analytical test strip of FIG. 1. FIG. 6 is a top view of a third electrically conductive layer of the analytical test strip of FIG. 1.

Referring to FIGS. 1-6, analytical test strip 100 for use with a test meter in the determination of an analyte (such as glucose) in a bodily fluid sample (e.g., a whole blood sample) according to an embodiment of the present invention includes a first insulating layer 102 with a first insulating layer upper surface 104 and a first electrically conductive layer 106 disposed on first insulating upper surface 104. First electrically conductive layer 106 includes a first electrode portion 108 and a first electrical contact pad 110 in electrical communication with first electrode portion 108. First electrode portion 108 and first electrical contact pad 110 are typically, for example, defined from contiguous first electrically conductive layer 106 by a patterned spacer layer 112.

Analytical test strip 100 also includes the aforementioned patterned spacer layer 112 disposed above first electrically conductive layer 106. Patterned spacer layer 112 has a distal portion 114 defining a bodily fluid sample-receiving chamber 116 therein that overlies first electrode portion 108. Patterned spacer layer 112 also has an insulating proximal portion 118 with an upper surface 120 and a second electrically conductive layer 122 disposed thereon. Moreover, second electrically conductive layer 122 has an interlayer contact portion 124 and an electrical contact pad 126.

Analytical test strip 100 further includes a second insulating layer 128 disposed above patterned spacer layer 112. Second insulating layer 128 has a second insulating layer lower surface 130. Analytical test strip 100 yet further includes a third electrically conductive layer 132 disposed on second insulating layer lower surface 130 that includes a second electrode portion 134 and a proximal portion 136 that overlies interlayer contact portion 124. Second electrode portion 134 is disposed overlying and exposed to bodily fluid sample-receiving chamber 116 and in an opposing (i.e., co-facial) relationship to first electrode portion 108. Analytical test strip 100 also includes a reagent layer 138 (see FIG. 1 in particular). If desired, reagent layer 138 can have dimensions that ensure complete coverage of first electrode portion 108 despite manufacturing variation.

In analytical test strip 100, the proximal portion of the third electrically conductive layer is operatively juxtaposed with the interlayer contact portion of the second electrically conductive layer such that there is an electrical connection between the second electrode portion of the third electrically conductive layer and the electrical contact pad of the patterned spacer layer during use of the analytical test strip. This electrical connection provides for unidirectional stacked electrical contact pads even though the first and second electrode portions are in an opposing (i.e., co-facial) arrangement.

The proximal portion of the third electrically conductive layer can be operatively juxtaposed with the inter layer contact portion by, for example, attachment with an electrically conductive adhesive or by compression of a gap therebetween (in the direction of arrow A of the distal portion depicted in FIG. 4) upon insertion into the test meter. Such a compression can be achieved, for example, by the application of a force in the range of 3 pounds per square-inch to 30 pounds per square inch. The operative juxtaposition can be provided by any known means including an electrically fused joint or an electrically conductive foil connection.

First and second electrical contact pads 110 and 126, respectively, are each configured to operatively interface with a test meter via electrical contact with separate electrical connector pins (labeled ECP in FIGS. 3 and 4) of the test meter.

First insulating layer 102, insulating proximal portion 118, and second insulating layer 128 can be formed, for example, of a plastic (e.g., PET, PETG, polyimide, polycarbonate, polystyrene), silicon, ceramic, or glass material. For example, the first and second insulating layers can be formed from a 7 mil polyester substrate.

In the embodiment of FIGS. 1-6, first electrode portion 108 and second electrode portion 134 are configured to electrochemically determine analyte concentration in a bodily fluid sample (such as glucose in a whole blood sample) using any suitable electrochemical-based technique known to one skilled in the art.

The first, second and third electrically conductive layers, 106, 122 and 132 respectively, can be formed of any suitable conductive material such as, for example, gold, palladium, carbon, silver, platinum, tin oxide, iridium, indium, or combinations thereof (e.g., indium doped tin oxide). Moreover, any suitable technique can be employed to form the first, second and third conductive layers including, for example, sputtering, evaporation, electro-less plating, screen-printing, contact printing, or gravure printing. For example, first electrically conductive layer 106 can be a sputtered palladium layer and third electrically conductive layer 132 can be a sputtered gold layer.

Distal portion 114 of patterned spacer layer 112 serves to bind together first insulating layer 102 (with first electrically conductive layer 106 thereon) and second insulating layer 128 (with third electrically conductive layer 132 thereon), as illustrated in FIGS. 1, 2, 3 and 4. Patterned spacer layer 112 can be, for example, a double-sided pressure sensitive adhesive layer, a heat activated adhesive layer, or a thermo-setting adhesive plastic layer. Patterned spacer layer 112 can have, for example, a thickness in the range of from about 50 micron to about 300 microns, preferably between about 75 microns and about 150 microns. The overall length of analytical test strip 100 can be, for example, in the range of 30 mm to 50 mm or the range of 8 mm to 12 mm and the width can be, for example, in the range of 2 mm to 5 mm.

Reagent layer 134 can be any suitable mixture of reagents that selectively react with an analyte such as, for example glucose, in a bodily fluid sample to form an electroactive species, which can then be quantitatively measured at an electrode of analyte test strips according to embodiments of the present invention. Therefore, reagent layer 138 can include at least a mediator and an enzyme. Examples of suitable mediators include ferricyanide, ferrocene, ferrocene derivatives, osmium bipyridyl complexes, and quinone derivatives. Examples of suitable enzymes include glucose oxidase, glucose dehydrogenase (GDH) using a pyrroloquinoline quinone (PQQ) co-factor, GDH using a nicotinamide adenine dinucleotide (NAD) co-factor, and GDH using a flavin adenine dinucleotide (FAD) co-factor. Reagent layer 134 can be formed using any suitable technique.

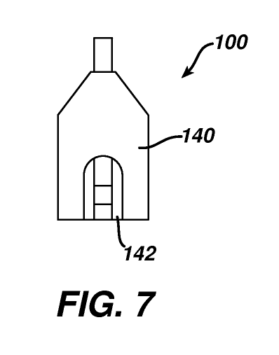

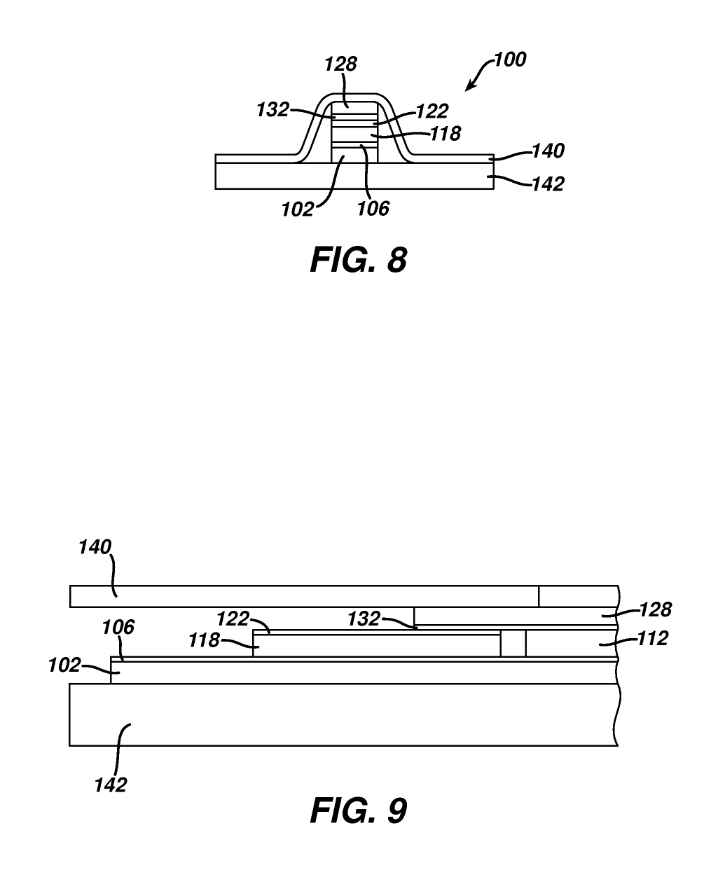

Referring to FIGS. 6, 7 and 8, if desired, analytical test strip 100 can further include at least one integrated carrier sheet configured solely as a user handle. In the embodiment of FIGS. 6-8, analytical test strip 100 includes a first integrated carrier sheet 140 and a second integrated carrier sheet 142. Moreover, a portion of the first insulating layer, first electrically conductive layer, patterned spacer layer, second insulating layer and second electrically conductive layer are disposed between first integrated carrier sheet 140 and second integrated carrier sheet 142. First integrated carrier sheet 140 is configured such that the electrical contact pad of the first electrically conductive layer and the electrical contact pad of the patterned spacer layer are exposed. Such exposure enables electrical contact to a test meter during use.

The first and second integrated carrier sheets can be formed of any suitable material including, for example, paper, cardboard, or plastic materials. Since the first and second integrated carrier sheets are configured solely as a user handle in the present embodiments, they can be formed of relatively inexpensive materials. Such integrated carrier sheets are beneficial in that, for example, they improve the ease of handling of an analytical test strip that may otherwise be relatively small and difficult to handle.

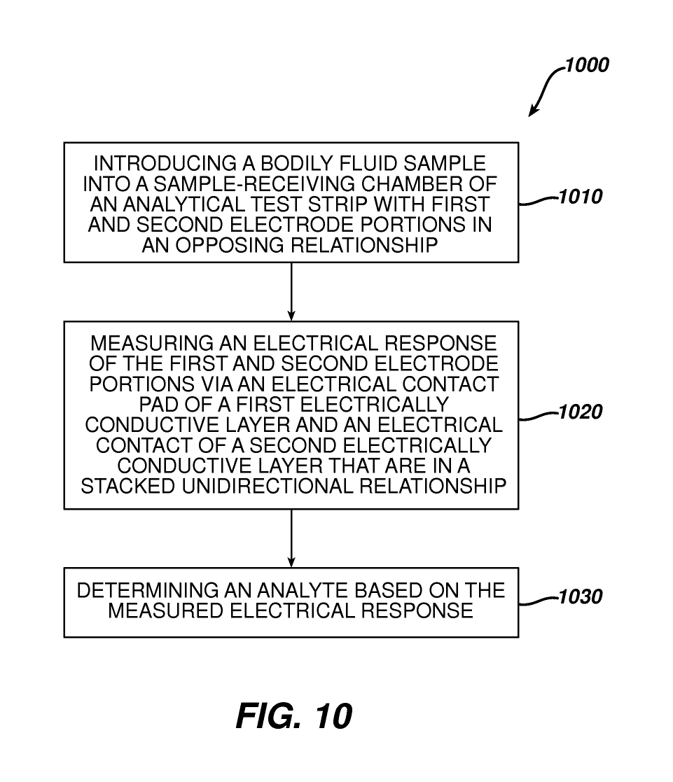

FIG. 10 is a flow diagram depicting stages in a method 1000 for determining an analyte (such as glucose) in a bodily fluid sample (for example, a whole blood sample). Method 1000 includes introducing a bodily fluid sample into a sample-receiving chamber of an analytical test strip that has a first electrode portion of a first electrically conductive layer and a second electrode portion of a third electrically conductive layer therein (see step 1010 of FIG. 10). In addition, the first electrode portion and the second electrode portion are in an opposing relationship.

At step 1020 of method 1000, an electrical response of the first electrode portion and the second electrode portion is measured via an electrical contact pad of the first electrically conductive layer and via an electrical contact pad of a second electrically conductive layer of a patterned spacer layer of the analytical test strip. The patterned spacer layer is disposed between the first electrically conductive layer and the third electrically conductive layer. Furthermore, the electrical contact pad of the first electrically conductive layer and the second electrically conductive layer are configured in a unidirectional stacked relationship and the second electrode portion is in electrical communication with the electrical contact pad of the second electrically conductive layer.

Method 1000 also includes, at step 1030, determining the analyte based on the measured electrical response.

Once apprised of the present disclosure, one skilled in the art will recognize that method 1000 can be readily modified to incorporate any of the techniques, benefits and characteristics of analytical test strips according to embodiments of the present invention and described herein.

In general, analytical test strips with an inert carrier substrate and for use with a test meter according to embodiments of the present invention include an analytical test strip module and an electrochemically and electrically inert carrier substrate (also referred to as an inert carrier substrate). The analytical test strip module has a first electrode portion, a second electrode portion in an opposing relationship to the first electrode portion, and first and second electrical contact pads in a stacked unidirectional configuration. The electrochemically and electrically inert carrier substrate has an upper surface and an outer edge. Moreover, the analytical test strip module is attached to the upper surface of the electrochemically and electrically inert carrier substrate such that the first and second electrical contact pads extend beyond the outer edge of the electrochemically and electrically inert carrier substrate and such that the electrochemically and electrically inert carrier substrate extends beyond the analytical test strip module.

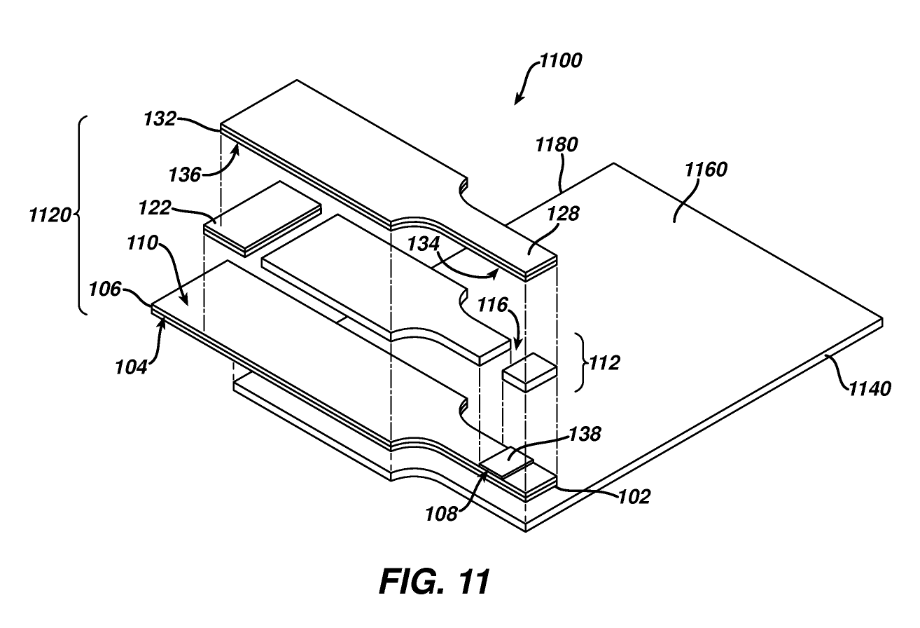

As described with reference to FIGS. 11 through 14 and depicted therein, the term “analytical test strip module” refers to a module that is attached to an inert carrier substrate to produce analytical test strips with an inert carrier substrate according to various embodiment of the present invention. Once apprised of the present disclosure, one skilled in the art will recognize that such analytical test strip modules are equivalent to that analytical test strips that are devoid of an inert carrier substrate according to inventive embodiments described elsewhere herein. This equivalency is reflected in the element label numbers of FIGS. 11, 12, 13 and 14.

The term “inert” as applied to an inert carrier substrate refers to a carrier substrate that is not electrically conductive and does not electrically or electrochemically affect, or participate in, the electrochemical and electrical functions of the analytical test strip module that is attached to the upper surface of the inert carrier substrate. Such an inert carrier substrate is also referred to herein as an “electrochemically and electrically inert carrier.”

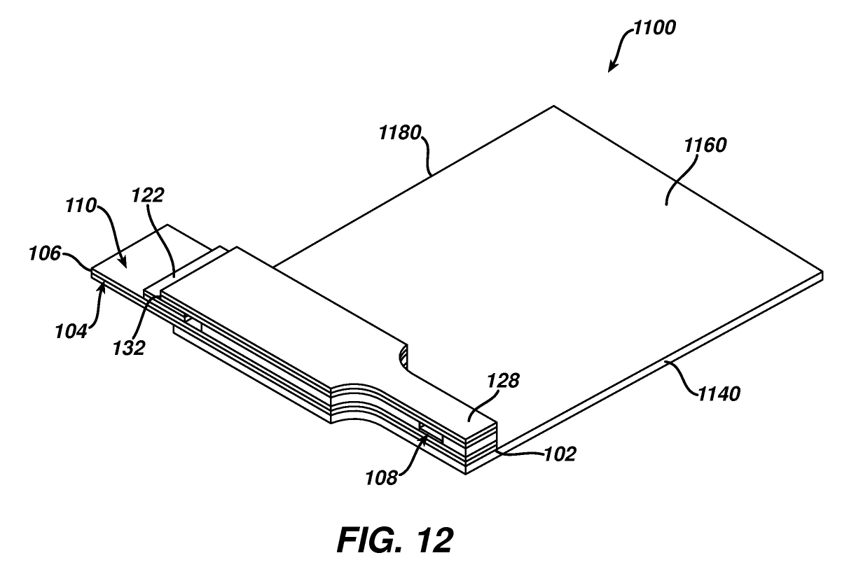

Analytical test strips with inert carrier substrates according to embodiments of the present invention are particularly beneficial in that the inert carrier substrate aids a user in manual handling of the analytical test strip and guiding insertion of the analytical test strip with inert carrier into a test meter. In addition, the analytical test strip module can be attached to the inert carrier substrate such that a bodily fluid sample is applied to a longitudinal side (i.e., side) of the analytical test strip module but an end (i.e., minor edge) of the inert carrier substrate (see FIGS. 11 and 12 in particular). In this regard, the side-fill configuration of the analytical test strip module when considered independently of the inert carrier substrate becomes an end-fill configuration of the analytical test strip with inert carrier. Such an end-fill configuration of the analytical test strip with inert carrier can be perceived as more user-friendly by some users.

Analytical test strips with inert carrier substrates according to embodiments of the present invention are also beneficial in that they can be easily and inexpensively manufactured since there is no electrical connection between the analytical test strip module and the inert carrier substrate and no need for precise alignment between the analytical test strip module and the inert carrier substrate.

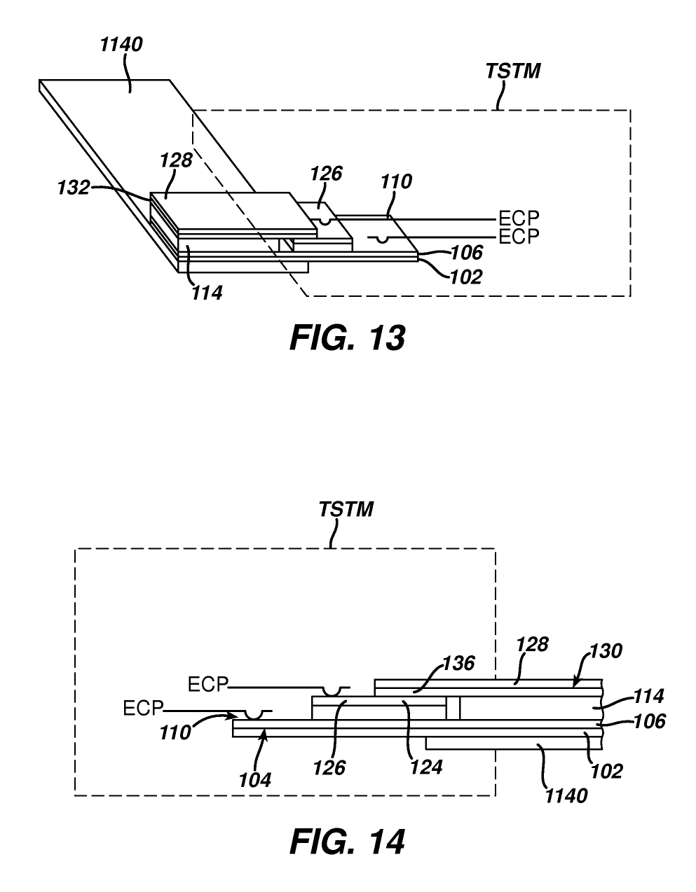

FIG. 11 is a simplified exploded perspective view of an analytical test strip with inert carrier substrate 1100 according to an embodiment of the present invention. FIG. 12 is a simplified perspective view of the analytical test strip with inert carrier substrate of FIG. 11. FIG. 13 is a simplified view of the distal portion of the analytical test strip with inert carrier substrate of FIG. 11 inserted into a test meter (TSTM, with only the outline depicted as a dashed line) and in contact with electrical connector pins (ECP) of the test meter. FIG. 14 is a simplified top view of the distal portion of the analytical test strip with inert carrier substrate inserted into a test meter as also depicted in FIG. 13.

Referring to FIGS. 11-14, analytical test strip with inert carrier substrate 1100 for use with a test meter includes an analytical test strip module 1120 with a first electrode portion 108 and a second electrode portion 134 that is in an opposing relationship to first electrode portion 108. Analytical test strip module 1120 also includes at least a first electrical contact pad 110 and a second electrical contact pad 126, the first and second electrical contact pads (110 and 126, respectively) configured in a stacked unidirectional configuration. The remainder of the elements of analytical test strip module 1120 has been described with respect to FIGS. 1 through 6 where like element labeling numerals indicating like elements.

Analytical test strip with inert carrier substrate 1100 also includes an electrochemically and electrically inert carrier substrate 1140 with an upper surface 1160 and an outer edge 1180 (see FIG. 12 in particular).

Analytical test strip module 1120 is attached to upper surface 1160 of the such that first electrical contact pad 110 and the second electrical contact pad 126 extend beyond outer edge 1180 of the electrochemically and electrically inert carrier substrate 1140. Moreover, the attachment configuration is such that the electrochemically and electrically inert carrier substrate 1140 extends beyond the analytical test strip module 1120, thus leaving a portion of upper surface 1160 exposed (see, for example, FIG. 12).

Referring to FIGS. 12, 13 and 14 in particular, the extension of the first electrical contact pad and the second electrical contact pad is configured for the operable insertion of the first electrical contact pad and the second electrical contact pad into a test meter. Moreover, it should be noted that in the embodiment of FIGS. 11-14, the analytical test strip module is attached lengthwise along a minor edge of the inert carrier substrate such that the sample-receiving chamber (which is on the edge of the analytical test strip module) is on an end of the inert carrier substrate.

Analytical test strip module 1120 can be attached to the inert carrier substrate using any suitable technique including, for example, adhesion and lamination techniques.

Electrochemically and electrically inert carrier substrate 1140 can be formed of any suitable material including, for example, plastic materials (e.g., a polyethylene material including Dupont Melinex material (DuPont Corporation) with a thickness in the range of 200 μm to 500 μm). The rigidity of the material used to form the inert carrier substrate should be sufficient such that there is operationally minimal deformation of inert carrier substrate when in use. The electrochemically and electrically inert carrier substrate should not substantially buckle or bend when the analytical test strip with inert carrier is inserted into the test meter (TSTM) and contact made between the first and second electrical contact pads and ECP of the test meter (see, for example, FIGS. 13 and 14).

Analytical test strip module 1120 and electrochemically and electrically inert carrier substrate 1140 can be of any suitable dimensions. Representative, but non-limiting dimensions for the analytical test strip are a width in the range of 2.0 mm to 3.5 mm and a length of approximately 10.0 mm. Electrochemically and electrically inert carrier substrate 1140 can have, for example, a width of 8.0 mm, a length of 35. 0mm and a thickness in the range of 200 μm to 500 μm). For these representative dimensions, the first and second contact pads of analytical test strip module 1120 will extend beyond the edge of the electrochemically and electrically inert carrier substrate by 2.00 mm (since the length of the analytical test strip module is attached across the width of the inert carrier substrate) and the electrochemically and electrically inert carrier substrate will extend beyond the analytical test strip module by at least 31.5 mm to 33.0 mm. See, in particular, FIG. 12 where both extensions are depicted.

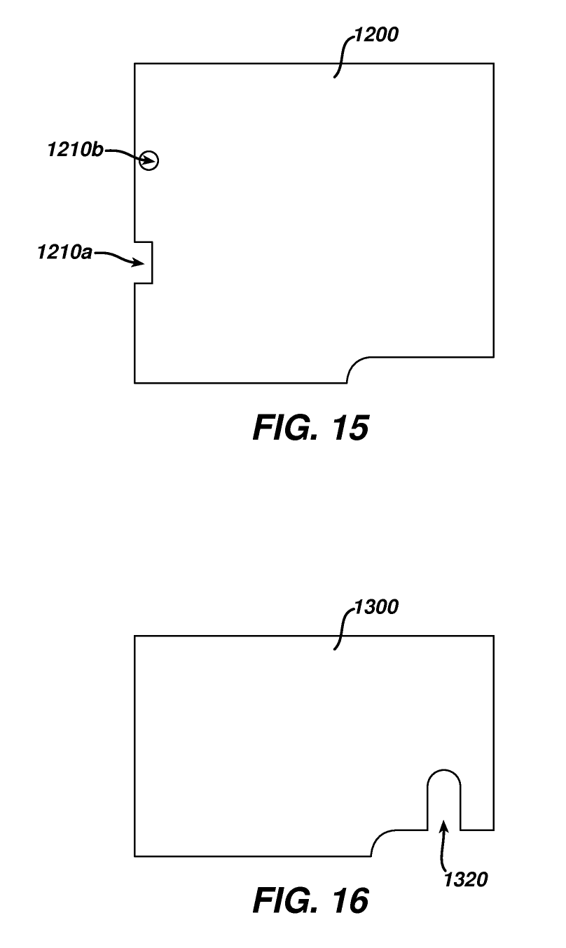

FIG. 15 is a simplified top view of another electrochemically and electrically inert carrier substrate 1200 as can be employed in embodiments of the present invention. Electrochemically and electrically inert carrier substrate 1200 includes mechanical physical alignment features 1210a (namely a notch) and 1210b (namely a circular opening through the inert carrier substrate) configured to aid in the insertion of analytical test strip and electrochemically and electrically inert carrier substrate into a test meter. Such mechanical physical alignment features are configured to mate with a corresponding feature of a test meter only when the analytical test strip and electrochemically and electrically inert carrier substrate have been correctly oriented and inserted into the test meter. If desired, a surface of the electrochemically and electrically inert carrier substrate can include an informational marking such as, for example, a bar code, logo, and/or a mark designating calibration information. Providing such informational marking on the inert carrier substrate enables various optimized and flexible supply chain management strategies. For example, an inert carrier substrates with appropriate calibration code information thereon can be combined with analytical test strip modules following calibration of a batch of such analytical test strip modules. In addition, a security informational marking could be applied to the inert carrier substrates just prior to shipment.

FIG. 16 is a simplified top view of yet another electrochemically and electrically inert carrier substrate 1300 as can be employed in embodiments of the present invention. Electrochemically and electrically inert carrier substrate 1300 includes a sample-cavity avoidance notch 1320 aligned with the sample-receiving chamber of the associated analytical test strip module (not shown in FIG. 16 for clarity purposes). The placement of sample-cavity avoidance notch 1320 is such that the inadvertent creation of cavities between the electrochemically and electrically inert carrier substrate and the analytical test strip module in the vicinity of bodily fluid sample application is prevented. Such cavities could, if present, present the opportunity for undesirable bodily fluid sample flow into the cavity instead of into the sample-receiving chamber.

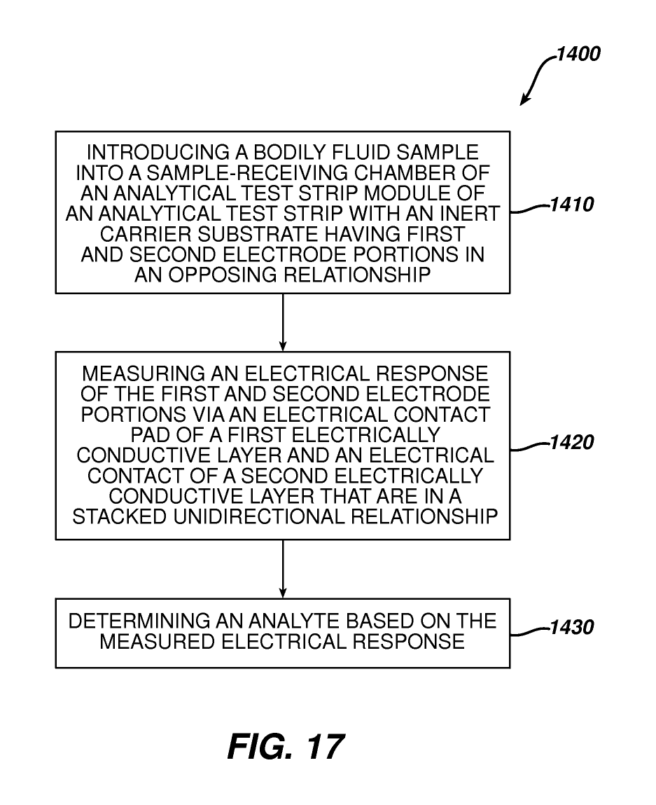

FIG. 17 is a flow diagram depicting stages in a method 1400 for determining an analyte (such as glucose) in a bodily fluid sample (for example, a whole blood sample). Method 1400 includes introducing a bodily fluid sample into a sample-receiving chamber of an analytical test strip module of an analytical test strip with inert carrier substrate that has a first electrode portion of a first electrically conductive layer and a second electrode portion of a third electrically conductive layer therein (see step 1410 of FIG. 17). In addition, the first electrode portion and the second electrode portion are in an opposing relationship.

At step 1420 of method 1400, an electrical response of the first electrode portion and the second electrode portion is measured via a first electrical contact pad of the first electrically conductive layer and via a second electrical contact pad of a second electrically conductive layer of the analytical test strip module. Furthermore, the first electrical contact pad of the first electrically conductive layer and the second electrical contact pad of the second electrically conductive layer are configured in a unidirectional stacked relationship and the second electrode portion is in electrical communication with the second electrical contact pad of the second electrically conductive layer and the inert carrier extends beyond the analytical test strip module.

Method 1400 also includes, at step 1430, determining the analyte based on the measured electrical response.

Once apprised of the present disclosure, one skilled in the art will recognize that method 1400 can be readily modified to incorporate any of the techniques, benefits and characteristics of analytical test strips with an inert carrier substrate according to embodiments of the present invention and described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. An analytical test strip with inert carrier substrate for use with a test meter, the analytical test strip comprising:
an analytical test strip module with:
a first electrode portion; and
a second electrode portion in an opposing relationship to the first electrode portion; and
at least first electrical contact pad and a second electrical contact pad, the first and second electrical contact pads configured in a stacked unidirectional configuration, and
an electrochemically and electrically inert carrier substrate with:
an upper surface, and
an outer edge,
wherein the analytical test strip module is attached to the upper surface of the electrochemically and electrically inert carrier substrate such that the first electrical contact pad and the second electrical contact pad extend beyond the outer edge of the electrochemically and electrically inert carrier substrate, and wherein the electrochemically and electrically inert carrier substrate extends beyond the analytical test strip module.

2. The analytical test strip with inert carrier substrate of claim 1, wherein the analytical test strip module further includes:
a first insulating layer with a first insulating layer upper surface;
a first electrically conductive layer disposed on the first insulating layer upper surface and including:
the first electrode portion; with the first electrical contact pad in electrical communication with the first electrode portion;
a patterned spacer layer disposed above the first electrically conductive layer and including:
a distal portion defining a bodily fluid sample-receiving chamber therein that overlies the first electrode portion; and
an insulating proximal portion with an upper surface and a second electrically conductive layer disposed thereon, the second electrically conductive layer including:
an interlayer contact portion; and
the second electrical contact pad;
a second insulating layer disposed above the patterned spacer layer and having a second insulating layer lower surface;
a third electrically conductive layer disposed on the third insulating layer lower surface and including:
the second electrode portion; and
a proximal portion overlying the interlayer contact portion,
wherein the second electrode portion is disposed overlying and exposed to the sample-receiving chamber and in an opposing relationship to the first electrode portion, and
wherein the proximal portion of the third electrically conductive layer is operatively juxtaposed with the interlayer contact portion of the second electrically conductive layer such that there is an electrical connection between the second electrode portion of the third electrically conductive layer and the electrical contact pad of the patterned spacer layer during use of the analytical test strip.

3. The analytical test strip with inert carrier substrate of claim 1 wherein the inert carrier substrate includes at least one mechanical physical alignment feature.

4. The analytical test strip with inert carrier substrate of claim 1 wherein the inert carrier substrate includes at least one sample cavity avoidance notch.

5. The analytical test strip with inert carrier substrate of claim 1 wherein the inert carrier substrate includes an informational marking.

6. The analytical test strip with inert carrier of claim 1 wherein the analytical test strip module is an electrochemical-based analytical test strip module.

7. The analytical test strip with inert carrier substrate of claim 6 wherein the electrochemical-based analytical test strip module is configured for the determination of an analyte in a bodily fluid sample.

8. The analytical test strip with inert carrier substrate of claim 7 wherein the analyte is glucose.

9. The analytical test strip with inert carrier substrate of claim 1 wherein the extension of the first electrical contact pad and the second electrical contact pad is configured for the operable insertion of the first electrical contact pad and the second electrical contact pad into a test meter.

10. The analytical test strip and inert carrier of claim 1 wherein the analytical test strip module is attached lengthwise along a minor edge of the inert carrier substrate.

11. A method for determining an analyte in a bodily fluid sample, the method comprising:
introducing a bodily fluid sample into a sample-receiving chamber of an analytical test strip module of an analytical test strip with inert carrier substrate, the sample receiving chamber having a first electrode portion of a first electrically conductive layer and a second electrode portion of a third electrically conductive layer therein, the first electrode portion and the second electrode portion being in an opposing relationship, and the inert carrier substrate extending beyond the analytical test strip module;
measuring an electrical response of the first electrode portion and the second electrode portion via a first electrical contact pad of the first electrically conductive layer and via a second electrical contact pad of a second electrically conductive layer of the analytical test strip module, and
wherein the first electrical contact pad of the first electrically conductive layer and the second electrical contact pad of the second electrically conductive layer are configured in a unidirectional stacked relationship and extend beyond an edge of the inert carrier substrate, and
wherein the second electrode portion is in electrical communication with the electrical contact pad of the second electrically conductive layer; and
determining the analyte based on the measured electrical response.

12. The method of claim 11 wherein the analytical test strip is an electrochemical-based analytical test strip.

13. The method of claim 12 where the analyte is glucose.

14. The method of claim 12 wherein the bodily fluid sample is a whole blood sample.

15. The method of claim 12 wherein the electrochemical-based analytical test strip is configured for the determination of an analyte in a bodily fluid sample.

16. The method of claim 11 wherein the measuring step employs a test meter and the measuring involves inserting the first electrical contact pad and the second electrical contact pad that extend beyond the edge of the inert carrier substrate into the test meter.

17. The method of claim 16 wherein the inert carrier substrate includes at least one mechanical alignment feature that aids in the insertion.

18. The method of claim 11 wherein inert carrier substrate includes an informational marking.

19. The method of claim 11 wherein the inert carrier substrate includes a sample cavity avoidance notch.

20. The method of claim 11 wherein the extension of the first electrical contact pad and the second electrical contact pad is configured for the operable insertion of the first electrical contact pad and the second electrical contact pad into a test meter during the measurement step.
